(19) United States
(12) Patent Application Publication
(10) Pub. No.: US 2017/0012973 A1
(43) Pub. Date: Jan. 12, 2017

(54) TRUST FRAMEWORK FOR SECURED DIGITAL INTERACTIONS BETWEEN ENTITIES

(71) Applicants: Harish PARTHASARATHY, Bangalore (IN); Rupesh SHANTAMURTY, Bangalore (IN); HEWLETT PACKARD DEVELOPMENT COMPANY, L.P., Houston, TX (US)

(72) Inventors: Harish Parthasarathy, Bangalore (IN); Rupesh Shantamurty, Bangalore (IN)

(21) Appl. No.: 15/114,366

(22) PCT Filed: Jan. 30, 2014
(86) PCT No.: PCT/IN2014/000076

§ 371 Date: Jul. 26, 2016

(51) Int. Cl. H04L 29/06; H04L 29/08; H04L 9/32; H04L 9/14; H04L 9/30

(52) U.S. Cl. CPC H04L 63/0869; H04L 9/14; H04L 9/30; H04L 9/3263; H04L 63/06; H04L 63/0428; H04L 67/141

(57) ABSTRACT

A trust framework for secured digital interactions between entities is disclosed. In an example implementation, a secured digital interaction is initiated by a first entity with a second entity. Further, it is determined whether encrypted uniquely identifiable digital information associated with the second entity is stored in a first entity specific trust database. Furthermore, the secured digital interaction is established using encrypted uniquely identifiable digital information associated with the first entity and the second entity via a trust facilitator, if the encrypted uniquely identifiable digital information associated with the second entity is not stored in the first entity specific trust database. Also, the secured digital interaction is established using the encrypted uniquely identifiable digital information in the first entity specific trust database, if the encrypted uniquely identifiable digital information associated with the second entity is stored in the first entity specific trust database.

### BACKGROUND

In a digital environment, entities generally interface with users and/or other entities while performing a task. An entity is any application, part of hardware, embedded application, and the like. These entities may manage information associated with various businesses and individual users. However, flaws in such digital interactions have been exploited through various types of fraudulent activities for material gains. Phishing is one such fraudulent activity where confidential information may be obtained through the manipulation of legitimate users. The confidential information may include a user's password, credit card details, a social security number or any other such sensitive information. Phishing may be carried out by masquerading as a trustworthy person, a business, a website or an application. Another tool used for committing fraud in the digital environment is malware. A malware or malicious application may be illegitimate modification of an original application to gain unauthorized access or trust and sensitive information from associated users. The malware or malicious application may be used to disrupt operations and can cause damage to the entities or users by modifying the information. The widespread use of digital media as an information store has resulted in tremendous increase in fraudulent activities and targeted attacks. Detection and prevention of various types of fraudulent activities during digital interactions between the entities can be a security challenge.

### BRIEF DESCRIPTION OF THE DRAWINGS

FIG. 1A is a block diagram depicting an example trust framework for an initial secured digital interaction between entities.

FIG. 1B is a block diagram depicting an example trust framework for subsequent secured digital interactions between the entities.

FIGS. 2-5 depict example user interfaces for implementing the trust framework for secured digital interactions between two entities.

FIGS. 6A and 6B are flow diagrams depicting example methods for a trust framework for secured digital interactions between entities.

### DETAILED DESCRIPTION

In the following description and figures, some example implementations of systems and/or methods for a trust framework for secured digital interactions between entities are described. An entity is any application, part of hardware, embedded application, and the like that is capable of performing digital interactions. Various examples described below relate to an automated trust framework for digital security based on peer-to-peer authentication with minimum overhead. In these examples, once an authentication is established using the trust facilitator, the technique does not need the trust facilitator for subsequent digital interactions between the entities. More specifically, the examples described below relate to implementing the trust framework for digital security based on establishing trust between entities using a trust facilitator and entity specific trust databases. In these examples, the trust establishment happens transparent to the user and does not need manual intervention for establishing the trust.

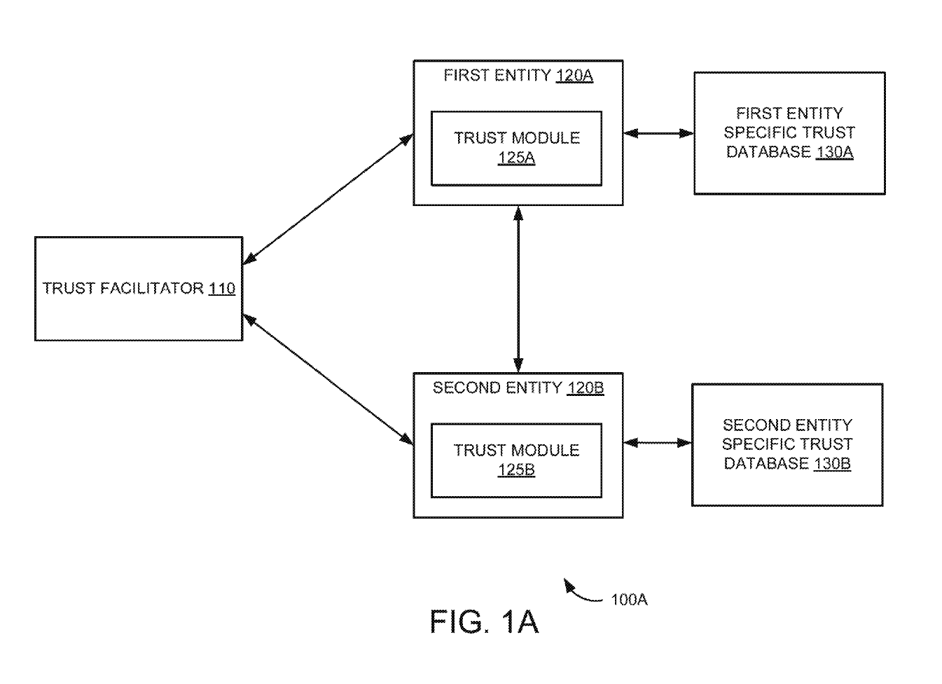

FIG. 1A is a block diagram depicting an example trust framework 100A for an initial secured digital interaction between entities. As shown in FIG. 1A, the trust framework 100A includes a trust facilitator 110 that is communicatively coupled to a first entity 120A and a second entity 120B. In an example, the trust facilitator 110 is communicatively coupled to the first entity 120A and the second entity 120B via a network or any other communication interface. Further, the first entity 120A and second entity 120B include a trust module 125A and a trust module 125B, respectively. The trust facilitator 110 and the trust modules 125A and 125B represent any combination of circuitry and executable instructions to run the trust framework 100A for the secured digital interaction using computing systems.

Furthermore, the trust framework 100A includes a first entity specific trust database 130A and a second entity specific trust database 130B communicatively coupled to the first entity 120A and second entity 120B, respectively. Example first and second entity specific trust databases 130A and 130B include trust stores. In an example, the first entity specific trust database 130A includes encrypted uniquely identifiable digital information associated with the first entity 120A and may also include encrypted uniquely identifiable digital information associated with the second entity 120B obtained during an earlier secured digital interaction. For example, uniquely identifiable digital information (e.g., a random number) can be system generated or can be transmitted digitally. Similarly, the second entity specific trust database 130B includes the encrypted uniquely identifiable digital information associated with the second entity 120B and may also include the encrypted uniquely identifiable digital information associated with the first entity 120A obtained during an earlier secured digital interaction.

In operation, the first entity 120A initiates the secured digital interaction with the second entity 1208. The term “digital interaction” here refers to data communication. In an example, the trust module 125A associated with the first entity 120A initiates the secured digital interaction with the second entity 120B. Further, the trust module 125A determines whether encrypted uniquely identifiable digital information associated with the second entity 120B is stored in the first entity specific trust database 130A. In other words, the trust module 125A determines whether it is an initial digital interaction or a subsequent digital interaction between the first entity 120A and the second entity 120B.

Furthermore, the trust modules 125A and 1258 establish the secured digital interaction between the first entity 120A and the second entity 120B using the encrypted uniquely identifiable digital information associated with the first entity 120A and the second entity 120B in the associated first entity specific trust database 130A and second entity specific trust database 130B via the trust facilitator 110, if the encrypted uniquely identifiable digital information associated with the second entity 120B is not stored in the first entity specific trust database 130A. In other words, the secured digital interaction is established between the first entity 120A and second entity 120B via the trust facilitator 110 and associated trust modules 125A and 125B when the first entity 120A desires to initially interact with the second entity 120B.

In an example implementation, the trust modules 125A and 1258 register the first entity 120A and the second entity 120B, respectively, with the trust facilitator 110. For example, the trust modules 125A and 125B register the first entity 120A and the second entity 120B, respectively, with the trust facilitator 110 using a secure digital authentication mechanism (e.g., a certificate mechanism). In an example, the trust modules 125A and 125B determine whether the first entity 120A and the second entity 120B, respectively, are registered with the trust facilitator 110. The trust modules 125A and 125B then register the first entity 120A and the second entity 120B, respectively, with the trust facilitator 110, if the first entity 120A and the second entity 120B are not registered with the trust facilitator 110.

Further, the trust modules 125A and 125B authenticate the first entity 120A and the second entity 120B using the encrypted uniquely identifiable digital information associated with the first entity 120A and the second entity 120B stored in the respective first and second entity specific trust databases 130A and 130B via the trust facilitator 110, if the first entity 120A and the second entity 120B are registered with the trust facilitator 110 or upon registering the first entity 120A and the second entity 120B with the trust facilitator 110.

In an example scenario, the trust module 125A sends the encrypted uniquely identifiable digital information associated with the first entity 120A to the trust facilitator 110. Upon receiving a request (e.g., a communication request or an interaction request) from the trust facilitator 110, the trust module 125B sends the encrypted uniquely identifiable digital information associated with the second entity 120B to the trust facilitator 110. Further, the trust facilitator 110 decrypts the encrypted uniquely identifiable digital information associated with the first entity 120A and encrypts the decrypted uniquely identifiable digital information associated with the first entity 120A using a public key of the second entity 120B and sends the encrypted uniquely identifiable digital information associated with the first entity 120A to the second entity 120B. Furthermore, the trust facilitator 110 decrypts the encrypted uniquely identifiable digital information associated with the second entity 120B and encrypts the decrypted uniquely identifiable digital information associated with the second entity 120B using a public key of the first entity 120A and sends the encrypted uniquely identifiable digital information associated with the second entity 120B to the first entity 120A.

Moreover in this example scenario, the trust module 125B decrypts the received encrypted uniquely identifiable digital information associated with the first entity 120A using a private key of the second entity 120B, encrypts the decrypted uniquely identifiable digital information using the public key of the first entity 120A and sends the encrypted uniquely identifiable digital information to the first entity 120A. Further, the trust module 125A decrypts and verifies the received encrypted uniquely identifiable digital information and sends the result of the verification to the second entity 120B.

Also in this example scenario, the trust module 125A decrypts the received encrypted uniquely identifiable digital information associated with the second entity 120B using a private key of the first entity 120A, encrypts the decrypted uniquely identifiable digital information using the public key of the second entity 120B and sends the encrypted uniquely identifiable digital information to the second entity 120B. In addition, the trust module 125B decrypts and verifies the received encrypted uniquely identifiable digital information and sends the result of the verification to the first entity 120A.

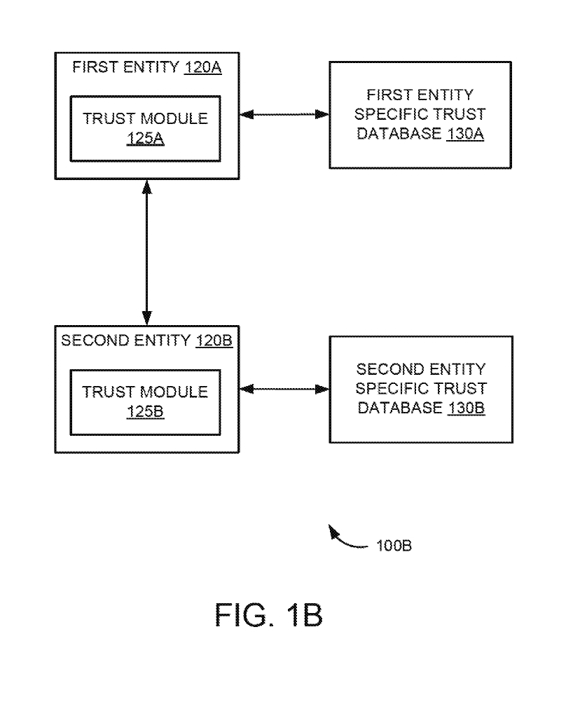

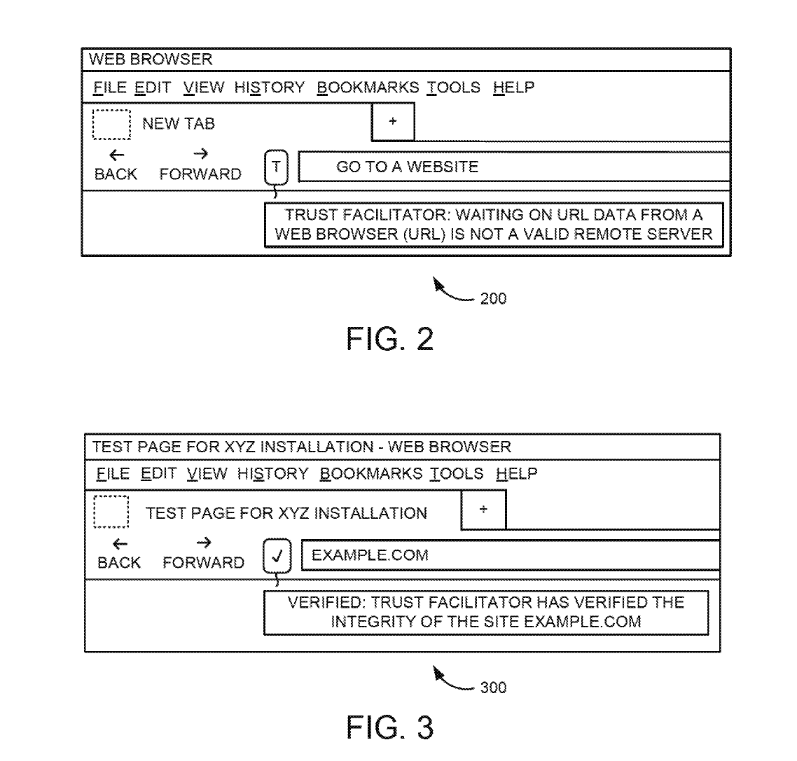

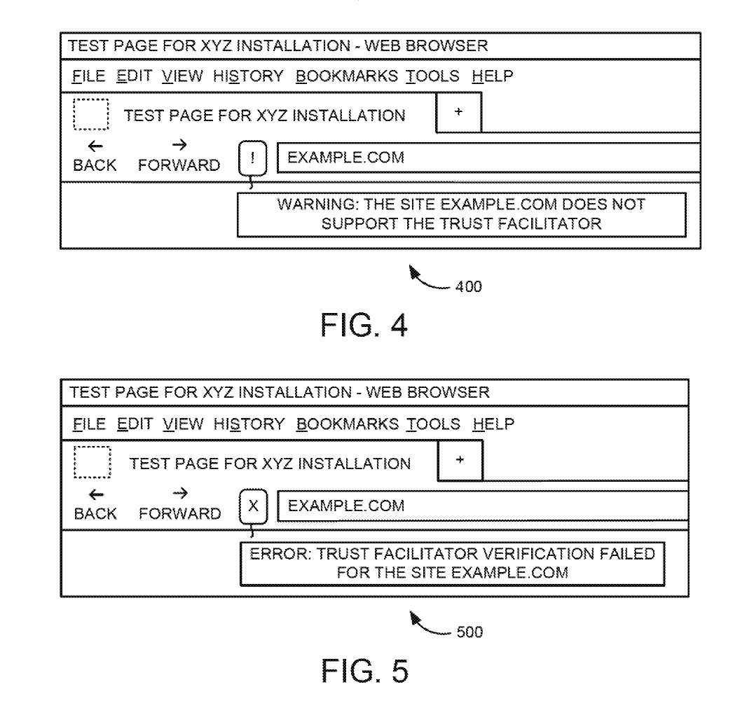

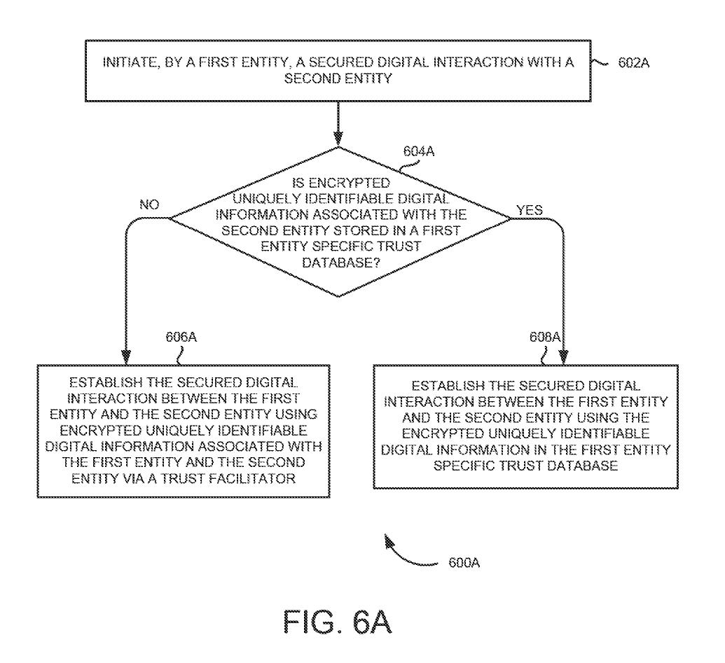

Furthermore in this example implementation, the trust modules 125A and 1258 establish the secured digital interaction between the first entity 120A and the second entity 120B upon successful verification. Also, the trust modules 125A and 125B encrypt and store the uniquely identifiable digital information associated with the first entity 120A and second entity 120B in the associated first and second entity specific trust databases 130A and 130B upon successful verification. FIGS. 2-5 depict example user interfaces 200, 300, 400, and 500 for implementing the trust framework 100A, as described above, for secured digital interactions between two entities (e.g., a web browser and a web server).

Moreover in this example implementation, the trust modules 125A and 125B establish the secured digital interaction between the first entity 120A and the second entity 120B using the encrypted uniquely identifiable digital information associated with the first entity 120A and second entity 120B, if the encrypted uniquely identifiable digital information associated with the second entity 120B is stored in the first entity specific trust database 130A. In other words, the secured digital interaction is established between the first entity 120A and the second entity 120B using the encrypted uniquely identifiable digital information associated with the first entity 120A and second entity 120B when the first entity 120A desires to digitally interact with the second entity 120B for subsequent time. This is explained in more detail with reference to FIG. 1B.

Referring now to FIG. 1B, which is a block diagram depicting an example trust framework 100B for subsequent secured digital interactions between entities. As shown in FIG. 1B, the trust framework 100B includes the first entity 120A and second entity 120B. Also, the trust framework 100B includes the first and second entity specific trust databases 130A and 130B communicatively coupled to the associated first entity 120A and second entity 120B. The first and second entity specific trust databases 130A and 130B includes encrypted uniquely identifiable digital information associated with the first entity 120A and second entity 120B obtained during the earlier secured digital interaction. Further, the first entity 120A and the second entity 120B include the associated trust modules 125A and 125B.

In an example implementation, the trust modules 125A and 125B establish the secured digital interaction between the first entity 120A and the second entity 120B upon authenticating the first entity 120A and the second entity 120B using the encrypted uniquely identifiable digital information associated with the first entity 120A and second entity 120B. In an example scenario, the trust module 125A sends the encrypted uniquely identifiable digital information associated with the second entity 120B that is stored in the first entity specific trust database 130A to the second entity 120B. Further, the trust module 125B sends the encrypted uniquely identifiable digital information associated with the first entity 120A that is stored in the second entity specific trust database 1308 to the first entity 120A, upon receiving a request from the first entity 120A.

Furthermore, the trust module 125A decrypts the encrypted uniquely identifiable digital information received from the second entity 120B and verifies the authenticity of the decrypted uniquely identifiable digital information and sends the result of the verification to the trust module 1258. In addition, the trust module 125B decrypts the encrypted uniquely identifiable digital information received from the first entity 120A and verifies the authenticity of the decrypted uniquely identifiable digital information and sends the result of the verification to the trust module 125A. Moreover, the associated trust modules 125A and 125B establish the secured digital interaction between the first entity 120A and the second entity 1208 upon successful verification.

Also, the trust module 125A generates new uniquely identifiable digital information associated with the first entity 120A and sends the new uniquely identifiable digital information to the second entity 120B, upon successful verification. Further, the trust module 1258 generates new uniquely identifiable digital information associated with the second entity 120B and sends the new uniquely identifiable digital information to the first entity 120A, upon successful verification. Furthermore, the trust module 125A encrypts and stores the new uniquely identifiable digital information associated with the first entity 120A and the second entity 120B in the first entity specific trust database 130A. In addition, the trust module 1258 encrypts and stores the new uniquely identifiable digital information associated with the first entity 120A and second entity 120B in the second entity specific trust database 130B. This new uniquely identifiable digital information associated with the first entity 120A and second entity 120B is used for subsequent digital interaction between the first entity 120A and the second entity 120B.

Even though the present technique is described for the first entity and second entity, it can be applicable to multiple entities. In the discussion herein, the trust facilitator 110 and/or the trust modules 125A and 125B have been described as a combination of circuitry and executable instructions. Such components can be implemented in a number of architectural configurations. Looking at FIGS. 1A and 1B, the executable instructions can be processor executable instructions, such as program instructions, or data stored in memory, such as the first and second entity specific trust databases 130A and 130B, which is a tangible, non-transitory computer readable storage medium, and the circuitry can be electronic circuitry, such as trust facilitator 110 and trust frameworks 100A and 100B, for executing those instructions. The trust frameworks 100A and 100B, for example, can include one or multiple processors. Such multiple processors can be integrated in a single device or distributed across devices. The memory can be said to store program instructions that when executed by the trust facilitator 110 and/or the first and second entities 120A and 120B implement the trust frameworks 100A or 100B. The first and second entity specific trust databases 130A and 130B can be integrated in the associated first and second entities 120A and 120B or it can be separate but accessible to associated first and second entities 120A and 120B. The memory can be distributed across devices. The first and second entity specific trust databases 130A and 130B can be shared by multiple entities to facilitate digital interactions across multiple entities used by the same user. Each entity includes a specific trust database but the database can be shared between multiple entities.

In one example, the executable instructions can be part of an installation package that when installed can be executed by the trust facilitator 110 and/or the first and second entities 120A and 120B to implement the trust frameworks 100A or 100B. In that example, the memory resource in the trust facilitator 110 and the first and second entity specific trust databases 130A and 130B can be a portable medium such as a CD, a DVD, a flash drive, or memory maintained by a computer device from which the installation package can be downloaded and installed. In another example, the executable instructions can be part of an application or applications already installed. Here, the memory resource in the trust facilitator 110 and the first and second entities 120A and 120B can include integrated memory such as a drive and the like.

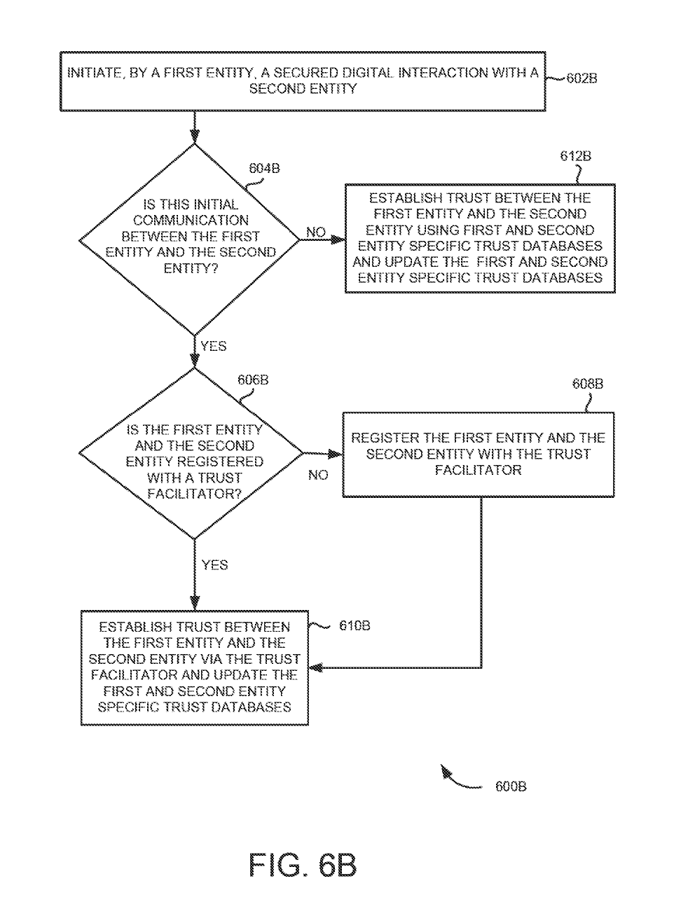

Further, the trust facilitator 110 can be implemented in a single server or multi-tier, distributed, hierarchical and/or clustered computing environments, distributed across several server devices, other devices or storage mediums, or a combination thereof. For example, an instance of the trust facilitator 110 can be executing on each one of the processor resources of the server devices. The trust facilitator and/or trust modules can complete or assist completion of operations performed in describing another engine and/or module. The trust facilitator 110 and/or trust modules 125A and 125B can perform the example methods described in connection with FIGS. 6A and 6B.

Referring now to FIG. 6A, which is a flow diagram 600A depicting an example method for a trust framework for secured digital interactions between entities. At block 602A, a secured digital interaction is initiated by a first entity with a second entity. At block 604A, it is determined whether encrypted uniquely identifiable digital information associated with the second entity is stored in a first entity specific trust database associated with the first entity. The first entity specific trust database includes encrypted uniquely identifiable digital information associated with the first entity and the encrypted uniquely identifiable digital information associated with the second entity obtained during an earlier secured digital interaction. At block 606A, the secured digital interaction between the first entity and the second entity is established using encrypted uniquely identifiable digital information associated with the first entity and the second entity via a trust facilitator, if the encrypted uniquely identifiable digital information associated with the second entity is not stored in the first entity specific trust database. This is explained in more detail with reference to FIG. 1A.

At block 608A, the secured digital interaction between the first entity and the second entity is established using the encrypted uniquely identifiable digital information in the first entity specific trust database, if the encrypted uniquely identifiable digital information associated with the second entity is stored in the first entity specific trust database. This is explained in more detail with reference to FIG. 1B.

FIG. 6B is a flow diagram 600B illustrating detailed process for a trust framework for secured digital interactions between entities. At block 602B, a secured digital interaction is initiated by a first entity with a second entity. At block 604B, a check is made to determine whether it is an initial communication between the first entity and the second entity. In other words, the first entity determines whether encrypted uniquely identifiable digital information associated with the second entity is stored in a first entity specific trust database associated with the first entity. At block 606B, a check is made to determine whether the first entity and second entity are registered with a trust facilitator, if it is the initial communication between the first entity and the second entity. At block 608B, the first entity and the second entity register with the trust facilitator, if the first entity and second entity are not registered with the trust facilitator. At block 610B, trust is established between the first entity and the second entity via the trust facilitator, if the first entity and second entity are registered with the trust facilitator or upon performing process step 608B. Further, the first entity specific trust database and a second entity specific trust database associated with the second entity are updated with the encrypted uniquely identifiable digital information associated with the first entity and second entity. This is explained in more detail with reference to FIG. 1A.

At block 6128, the trust is established between the first entity and the second entity using the encrypted uniquely identifiable digital information in the first and second entity specific trust databases, if it is not the initial communication between the first entity and the second entity. Further, new encrypted uniquely identifiable digital information associated with the first entity and second entity are generated and the first and second entity specific trust databases associated with the first entity and the second entity are updated with the new encrypted uniquely identifiable digital information associated with the first entity and second entity. This is explained in more detail with reference to FIG. 1B.

Although the flow diagrams of FIGS. 6A and 6B illustrate specific orders of execution, the order of execution can differ from that which is illustrated. For example, the order of execution of the blocks can be scrambled relative to the order shown. Also, the blocks shown in succession can be executed concurrently or with partial concurrence. All such variations are within the scope of the present technique. Further, even though the above technique is described using an asymmetric key cryptography for secured authentication, it can be envisioned that the technique can be implemented using a symmetric key cryptography or any other cryptographic mechanism as well.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the technique that is defined in the following claims.

What is claimed is:

1. A method for a trust framework for secured digital interactions between entities, comprising:
initiating, by a first entity, a secured digital interaction with a second entity;
determining whether encrypted uniquely identifiable digital information associated with the second entity is stored in a first entity specific trust database associated with the first entity, wherein the first entity specific trust database comprises encrypted uniquely identifiable digital information associated with the first entity and the encrypted uniquely identifiable digital information associated with the second entity obtained during an earlier secured digital interaction;
if not, establishing the secured digital interaction between the first entity and the second entity using encrypted uniquely identifiable digital information associated with the first entity and the second entity via a trust facilitator; and
if so, establishing the secured digital interaction between the first entity and the second entity using the encrypted uniquely identifiable digital information in the first entity specific trust database.

2. The method of claim 1, wherein establishing the secured digital interaction between the first entity and the second entity using encrypted uniquely identifiable digital information associated with the first entity and the second entity via a trust facilitator, comprises:
registering the first entity and the second entity with the trust facilitator using associated trust modules;
authenticating the first entity and the second entity using the encrypted uniquely identifiable digital information associated with the first entity and the second entity via the trust facilitator and the associated trust modules; and
establishing the secured digital interaction between the first entity and the second entity upon successful authentication.

3. The method of claim 2, wherein authenticating the first entity and the second entity using the encrypted uniquely identifiable digital information associated with the first entity and the second entity via the trust facilitator and the associated trust modules, comprises:
sending, by the associated trust module, the encrypted uniquely identifiable digital information associated with the first entity to the trust facilitator;
sending, by the associated trust module, the encrypted uniquely identifiable digital information associated with the second entity to the trust facilitator upon receiving a request from the trust facilitator;
decrypting the encrypted uniquely identifiable digital information associated with the first entity and the second entity and encrypting the decrypted uniquely identifiable digital information associated with the first entity and the second entity using a public key of the second entity and the first entity, respectively, and sending the encrypted uniquely identifiable digital information associated with the first entity to the second entity and the encrypted uniquely identifiable digital information associated with the first entity to the second entity, by the trust facilitator;
decrypting the received encrypted uniquely identifiable digital information associated with the first entity using a private key of the second entity, encrypting the decrypted uniquely identifiable digital information using the public key of the first entity and sending the encrypted uniquely identifiable digital information to the first entity, by the trust module associated with the second entity;
decrypting and verifying the received encrypted uniquely identifiable digital information and sending the result of the verification to the second entity, by the trust module associated with the first entity;
decrypting the received encrypted uniquely identifiable digital information associated with the second entity using a private key of the first entity, encrypting the decrypted uniquely identifiable digital information using the public key of the second entity and sending the encrypted uniquely identifiable digital information to the second entity, by the trust module associated with the first entity; and
decrypting and verifying the received encrypted uniquely identifiable digital information and sending the result of the verification to the first entity, by the trust module associated with the second entity.

4. The method of claim 3, further comprising
encrypting and storing, by the associated trust modules, the uniquely identifiable digital information associated with the first entity and second entity in the first entity specific trust database and a second entity specific trust database associated with the second entity upon successful verification.

5. The method of claim 1, wherein establishing the secured digital interaction between the first entity and the second entity using the encrypted uniquely identifiable digital information in the first entity specific trust database, comprises:
authenticating the first entity and the second entity using the encrypted uniquely identifiable digital information associated with the first entity and the second entity via associated trust modules; and
establishing the secured digital interaction between the first entity and the second entity upon successful authentication.

6. The method of claim 5, wherein authenticating the first entity and the second entity using the encrypted uniquely identifiable digital information associated with the first entity and the second entity via associated trust modules, comprises:
sending, by the trust module associated with the first entity, the encrypted uniquely identifiable digital information associated with the second entity, stored in the first entity specific trust database, to the second entity;
sending, by the trust module associated with the second entity, the encrypted uniquely identifiable digital information associated with the first entity, stored in a second entity specific trust database, to the first entity upon receiving a request from the first entity;
decrypting the encrypted uniquely identifiable digital information received from the second entity and verifying the authenticity of the decrypted uniquely identifiable digital information and sending the result of the verification to the trust module associated with the second entity, by the trust module associated with the first entity; and
decrypting the encrypted uniquely identifiable digital information received from the first entity and verifying the authenticity of the decrypted uniquely identifiable digital information and sending the result of the verification to the trust module associated with the first entity, by the trust module associated with the second entity.

7. The method of claim 6, further comprising:
generating new uniquely identifiable digital information associated with the first entity and sending the new uniquely identifiable digital information to the second entity upon successful verification, by the trust module associated with the first entity;
generating new uniquely identifiable digital information associated with the second entity and sending the new uniquely identifiable digital information to the first entity upon successful verification, by the trust module associated with the second entity;
encrypting and storing, by the trust module associated with the first entity, the new uniquely identifiable digital information associated with the first entity and the second entity in the first entity specific trust database; and
encrypting and storing, by the trust module associated with the second entity, the new uniquely identifiable digital information associated with the first entity and second entity in the second entity specific trust database.

8. A trust framework for secured digital interactions between entities, comprising:
a trust facilitator;
a first entity and a second entity communicatively coupled to the trust facilitator; and
a first entity specific trust database and a second entity specific trust database communicatively coupled to the associated first entity and second entity, wherein the first entity and the second entity comprise an associated trust module and wherein:
the trust module associated with the first entity is to initiate a secured digital interaction with the second entity;
the trust module associated with the first entity is to determine whether encrypted uniquely identifiable digital information associated with the second entity is stored in the first entity specific trust database, wherein the first entity specific trust database comprises encrypted uniquely identifiable digital information associated with the first entity and the encrypted uniquely identifiable digital information associated with the second entity obtained during an earlier secured digital interaction;
if not, the trust modules are to establish the secured digital interaction between the first entity and the second entity using encrypted uniquely identifiable digital information associated with the first entity and the second entity via the trust facilitator; and
if so, the trust modules are to establish the secured digital interaction between the first entity and the second entity using the encrypted uniquely identifiable digital information in the first entity specific trust database.

9. The trust framework of claim 8, wherein the associated trust modules are to:
register the first entity and the second entity with the trust facilitator;
authenticate the first entity and the second entity using the encrypted uniquely identifiable digital information associated with the first entity and the second entity via the trust facilitator; and
establish the secured digital interaction between the first entity and the second entity upon successful authentication.

10. The trust framework of claim 9, wherein the associated trust modules are further to:
encrypt and store the uniquely identifiable digital information associated with the first entity and second entity in the first and second entity specific trust databases upon successful authentication.

11. The trust framework of claim 8, wherein the associated trust modules are to:
authenticate the first entity and the second entity using the encrypted uniquely identifiable digital information associated with the first entity and the second entity; and
establish the secured digital interaction between the first entity and the second entity upon successful authentication.

12. The trust framework of claim 11, wherein:
the trust module associated with the first entity is further to generate new uniquely identifiable digital information associated with the first entity and send the new uniquely identifiable digital information to the second entity upon successful authentication;
the trust module associated with the second entity is further to generate new uniquely identifiable digital information associated with the second entity and send the new second uniquely identifiable digital information to the first entity upon successful authentication;
the trust module associated with the first entity is further to encrypt and store the new uniquely identifiable digital information associated with the first entity and the second entity in the first entity specific trust database; and
the trust module associated with the second entity is further to encrypt and store the new uniquely identifiable digital information associated with the first entity and second entity in the second entity specific trust database.

13. A non-transitory computer readable storage medium comprising a set of instructions executable by a processor resource to:
initiate, by a first entity, a secured digital interaction with a second entity;
determine whether encrypted uniquely identifiable digital information associated with the second entity is stored in a first entity specific trust database associated with the first entity, wherein the first entity specific trust database comprises encrypted uniquely identifiable digital information associated with the first entity and the encrypted uniquely identifiable digital information associated with the second entity obtained during an earlier secured digital interaction;
if not, establish the secured digital interaction between the first entity and the second entity using encrypted uniquely identifiable digital information associated with the first entity and the second entity via a trust facilitator; and
if so, establish the secured digital interaction between the first entity and the second entity using the encrypted uniquely identifiable digital information in the first entity specific trust database.

14. The non-transitory computer readable storage medium of claim 13, wherein the set of instructions is to:
register the first entity and the second entity with the trust facilitator using associated trust modules;
authenticate the first entity and the second entity using the encrypted uniquely identifiable digital information associated with the first entity and the second entity via the trust facilitator and the associated trust modules; and
establish the secured digital interaction between the first entity and the second entity upon successful authentication.

15. The non-transitory computer readable storage medium of claim 13, wherein the set of instructions is to:
authenticate the first entity and the second entity using the encrypted uniquely identifiable digital information associated with the first entity and the second entity via associated trust modules; and
establish the secured digital interaction between the first entity and the second entity upon successful authentication.
